(19) United States
(12) Patent Application Publication
(10) Pub. No.: US 2008/0236633 A1
(43) Pub. Date: Oct. 2, 2008

(54) Method And Device For Cleaning Welding Torches With Co2 Dry Ice

(76) Inventor: Jurgen Von Der Ohe, Halle (Saale) (DE)

Correspondence Address: COLLARD & ROE, P.C., 1077 NORTHERN BOULEVARD, ROSLYN, NY, 11576, US

(21) Appl. No.: 11/587,347

(22) PCT Filed: Apr. 22, 2005
(86) PCT No.: PCT/DE05/00745

§ 371 Date: Jan. 10, 2007

(30) Foreign Application Priority Data
Apr. 24, 2004 (DE) 10 2004 063 473.4

(51) Int. Cl. B08B 3/02

(52) U.S. Cl. 134/34; 134/198

(57) ABSTRACT

The invention relates to a process and devices for cleaning welding torches, for example in automated welding lines, on welding robots and in single-piece production, by means of a cold medium, preferably CO₂ dry ice, the CO₂ snow produced by expanding the pressurised liquid CO₂ being directly applied with low density in a uniform or intermittent manner to the surfaces to be cleaned of the contact pipe and gas nozzle by means of a cleaning head that fits the burner.

The invention relates to a method and a device for cleaning welding torches in automated welding lines, on welding robots, and in single-piece production.

Various methods for cleaning welding torches are known. There are methods that are based on mechanical cleaning. In this connection, one or more wire brushes, various milling tools, or mold millers are known.

It is a disadvantage in this connection that only the external region of the gas nozzle and a part of the contact pipe can be cleaned with these tools. The deposits of spatters and flue gas in the interior of the burner and the parting agents that are blown in are not completely removed. In the case of conical gas nozzles, the interior of the gas nozzle cannot be cleaned using this technology.

Another disadvantage has proven to be the circular configuration of the burner due to the necessary rotational movement of the tools, since this opposes an adaptation of the burner shape to the seam or point region. Changes in the shape of the burner require a change in the cleaning device.

Another disadvantage consists in the fact that the surface of the burner, which is smooth at first and usually nickel-plated, is worn off or roughened up due to the mechanical work. This roughening leads to a more rapid and greater contamination of the burner.

Cleaning using a magnet is also known. For this purpose, the burner is immersed into a special bath, and the adhering spatters are removed using a magnet. This cleaning technology is only suitable for ferrous metals. This method is not suitable for cleaning welding burners used for welding Al, stainless steel, or bronze.

A cleaning technology is described in WO 02/49794 that cleans the welding burner using a CO₂ air mixture, utilizing thermotension, which occurs in the case of metals at different temperatures. A disadvantage in the case of this technology is that the contact pipe cannot be cleaned completely, since the CO₂ pellets become effective only when they directly impact the surface to be cleaned. The rotating jet nozzle increases the cleaning performance, but cannot become effective all the way to the gas inlet bores. Furthermore, the metering of the pellets in accordance with the cleaning task and mixing the compressed air stream is a disadvantage. Condensate formation and the related icing up of the metering unit in case of extended down times has also proven to be a disadvantage.

A technology is described in JP 07314142 A that is supposed to prevent the adhesion of spatters. For this purpose, a parting agent is sprayed onto the cold burner before the welding process.

The invention indicated in claim 1 to 3 is based on the problem of creating a cleaning method and a device for contact-free cleaning of welding burners, independent of whether these are single-wire burners or multi-wire burners.

This problem is solved, in accordance with claim 1 to 3, by means of a method for cleaning welding burners, for example in robot cells that operate automatically, using a cold jet medium, preferably CO₂ snow, which is blown onto the surface to be cleaned, uniformly or at intervals, and is guided past the surface to be cleaned by means of compulsory guidance, whereby the special cleaning head is moved on the axis of the contact pipe, in linear manner.

According to claim 4 to 7, the device for implementing the method consists of a cleaning sleeve that is dependent on the outside diameter of the contact pipe and the inside diameter of the gas nozzle, which sleeve can be displaced on the common axis of contact pipe and cleaning head, either in linear manner or at a certain angle to the welding burner.

The pressure of approximately 50 bar that is required in the uptake bottle or in the tank in order to maintain the liquid phase of the CO₂ is used directly for cleaning the outside surface of the contact pipe and the gas nozzle. The liquid CO₂, which is under pressure, is blown into the cleaning sleeve by way of one or more nozzles at the base of the cleaning sleeve, whereby the inflow angle can be different, uniformly or at one or more short intervals. The CO₂ snow that is formed when the liquid CO₂ relaxes is immediately used for cleaning, i.e. for supercooling of the adhering spatters, while at the same time there is slight condensation due to the compulsory guidance in the cleaning sleeve. The condensation is achieved by means of the volume increase during relaxation and by means of the limitation of the expansion region by the inside diameter of the cleaning sleeve. In order for the condensation of the CO₂ snow not to cause the cleaning sleeve to become blocked up, a certain ratio of nozzle cross-section to inside diameter of the cleaning sleeve must be maintained. When using uptake bottles below room temperature, the ratio of 1:13 has proven to be advantageous. The large mass differences between contact pipe and gas nozzle in relationship to the welding spatters result in more rapid cooling of the spatters and, because of the shrinkage connected with this, loosening of the spatters. For pressure equalization in the cleaning sleeve during relaxation of the liquid CO₂, the cleaning sleeve can be provided with lateral bores.

Cleaning of the welding burner takes place in at least two stages. In the first stage, the adapted cleaning head, with the cleaning sleeve, stands at a distance in front of the gas nozzle that is dependent on the outside diameter of the gas nozzle. At this distance, cleaning of the gas exit opening of the gas nozzle takes place by means of short-term application of CO₂ snow. Subsequently, the welding burner moves into the cleaning sleeve with the contact pipe, and over the cleaning sleeve with the gas nozzle. With another CO₂ pulse and because of the compulsory guidance brought about by the cleaning position, the outside region of the contact pipe and the inside region of the gas nozzle are cleaned.

The advantage of the invention consists in the fact that because of the use of the cold jet technique, particularly because of the use of CO₂ snow and a cleaning sleeve adapted to the burner, cleaning of the burners can be carried out without contact and without additional clamping procedures that result in changing the position of the burner and therefore can be the cause for faulty welds. Limited cooling and loosening of contaminants takes place by means of the CO₂ snow, mainly as the result of the thermotension that is provoked in this connection, while the CO₂ snow/air stream brought about by the phase transition and promoted by the compulsory guidance through the cleaning sleeve flushes the loosened contaminants out.

Another advantage of the invention is that because of the use of CO₂ snow, i.e. of the cold jet technique, there is no direct contact with the welding burner and therefore the surface of the welding burner is not damaged or worn away.

It is furthermore advantageous that because of the contact-free cleaning, the burner shape can be adapted to the corresponding welding task in significantly better manner, and therefore welding in grooves, corners, or in tight regions is simplified or made possible.

A further development of the invention consists in the fact that in the case of fixed welding burners, the cleaning device is mounted on a sled and the method is implemented, in the individual cleaning positions, by means of the sled.

In a continuation of the solution according to the invention, the liquid CO₂ is guided to directly in front of the gas nozzle, within the wall of the cleaning sleeve, and immediately blown onto the face surface of the gas nozzle as it relaxes.

In a further continuation of the solution according to the invention, cleaning is carried out with two separate cleaning sleeves. In the case of multi-wire or tandem burners, the gas nozzle encloses one or more contact pipes. In the first stage of cleaning, the liquid CO₂ is guided onto the face surface of the gas nozzle directly, at different inflow angles, from a ring of small nozzles. The ring is adapted to the contour of the gas nozzle. In the second stage, the contact pipe(s) is/are cleaned, whereby the burner is guided by the robot in such a manner that the cleaning sleeve is passed uniformly over the contact pipe to be cleaned.

An embodiment of the solution according to the invention that goes further is cleaning and blowing the burner out from the rear. For this purpose, the cleaning sleeve is moved directly over the contact pipe, and the liquid CO₂, which is under pressure, is guided forward in the wall of the cleaning sleeve. Because of the relaxation pressure, the CO₂ snow is guided both onto the gas nozzle and onto the contact pipe. Bores in the cleaning sleeve make it possible for the CO₂ snow to flow out, and prevent build-up of pressure. This variant of the burner cleaning can also be carried out in two stages, as already described. In the first stage, cleaning of the gas nozzle exit opening takes place, and in the second stage, cleaning of the inside region of the burner takes place.

It is obvious that the material, the additive material, and the welding parameters have an influence on the shape and size of the welding spatters. This also requires an adaptation of the cleaning device to the existing working conditions. This adaptation consists of a stepped embodiment of the cleaning sleeve.

As a result of combining the various embodiments according to the invention, there are additional advantages of contact-free cleaning by means of direct adaptation of the cleaning variant to the welding process.

### EXEMPLARY EMBODIMENT

In the following, the invention will be explained in greater detail using four examples. The drawing shows:

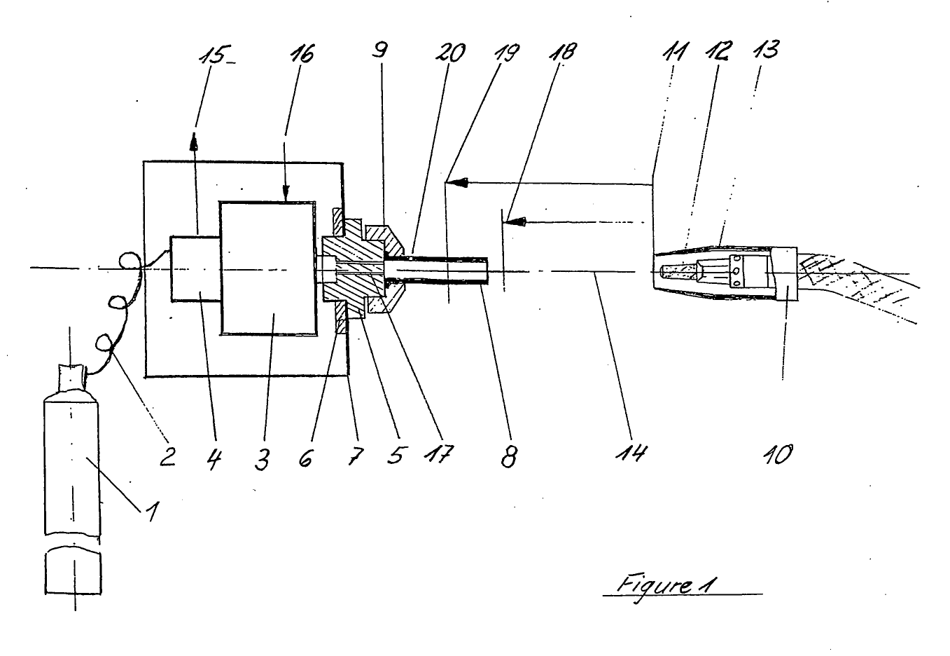

FIG. 1: Structure of a cleaning device for single-wire burners

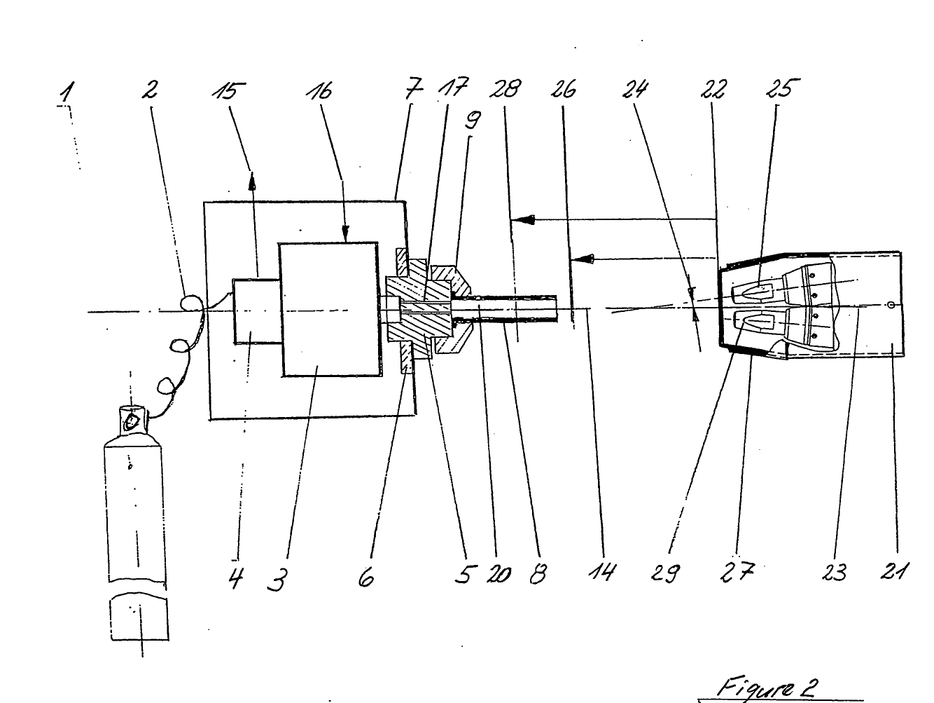

FIG. 2: Structure of a cleaning station for multi-wire burners (tandem burners)

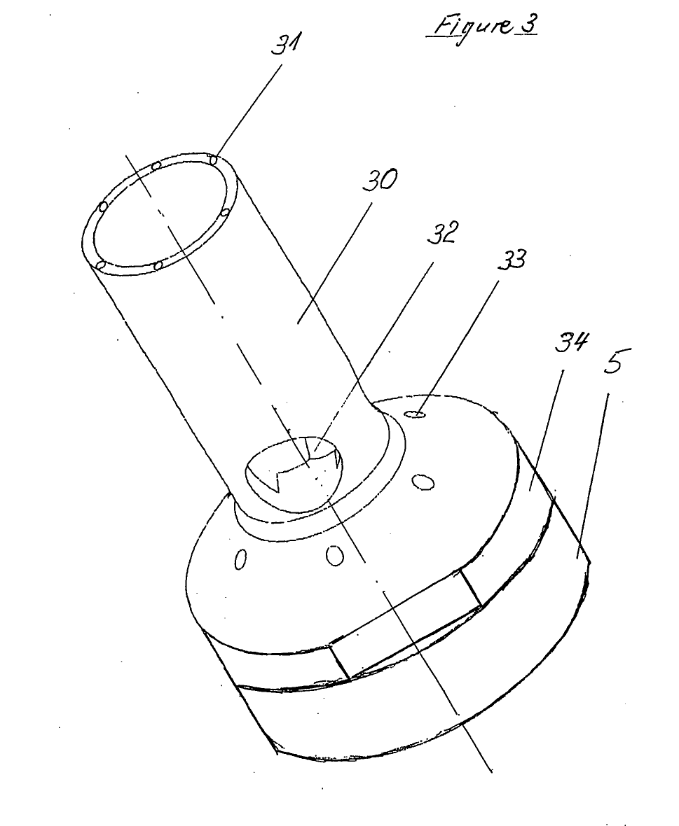

FIG. 3: Replaceable cleaning sleeve with inside bores for targeted guidance of the liquid CO₂

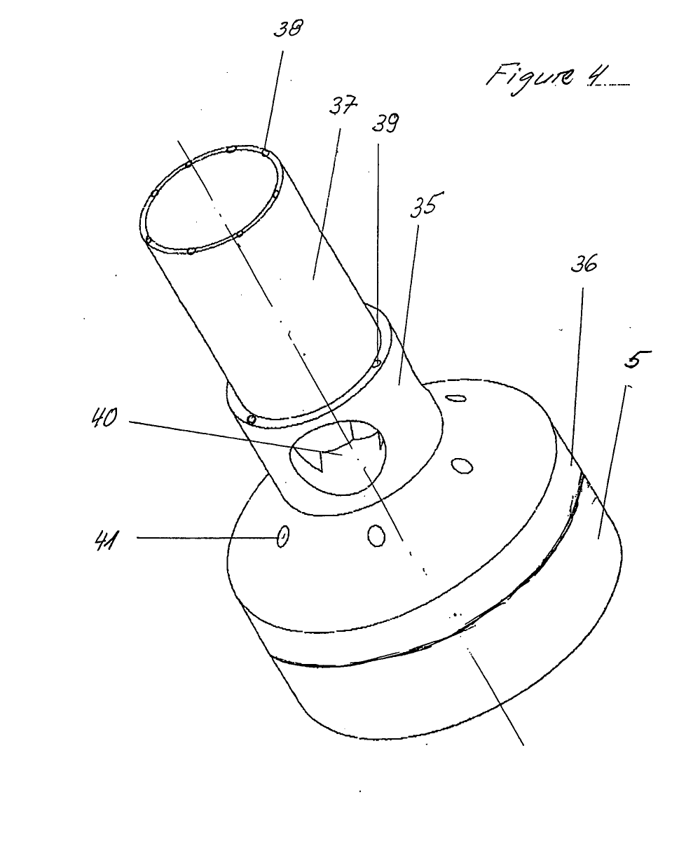

FIG. 4: Stepped cleaning sleeve

### EXAMPLE 1

Liquid CO₂ is guided from a CO₂ liquid tank 1 to the valve 3, by way of a pressure line 2. A measurement device 4 is situated ahead of the valve 3, to monitor the liquid CO₂ level. The valve 3 is directly connected with the cleaning head 5. The cleaning head 5 is held in the housing 7 by means of the nut 6. The cleaning pipe 8 is positioned by means of the union nut 9. For cleaning, the welding burner 10 is moved from the working position into the starting position 11, and oriented in such a manner that the contact pipe 12 and the gas nozzle 13 lie on the center line 14, together with the cleaning pipe 8. After orientation, the welding burner 10 moves out of the starting position 11 into the first cleaning position 18. If the measurement device 4 confirms, by means of the signal 15, that CO₂ liquid is present, the robot gives the signal 16 for opening the valve 3. The liquid CO₂ flows through the nozzle openings 17 into the cleaning pipe 8 and relaxes, with simultaneous slight condensation, to form CO₂ snow that is blown onto the exit opening of the gas nozzle 13 by means of the pressure in the bottle 1. The required pressure equalization is achieved by means of the equalization bores 20. Once the exit opening of the gas nozzle 13 has been cleaned, the welding burner 10 moves from the first cleaning position 18 into the second cleaning position 19. In this connection, the contact pipe 12 moves into and the gas nozzle 13 moves over the cleaning pipe 8. Once the position 19 has been reached, the valve 3 is opened by means of the signal 16 and CO₂ snow is again blown into the cleaning pipe 8. Because of the contact pipe 12 being moved in, the CO₂ snow is necessarily guided past the contact pipe 12 and the inside surface of the gas nozzle 13. After successful cleaning, the welding burner 10 moves back into the starting position 11 and from there into the working position.

### EXAMPLE 2

Liquid CO₂ is guided from a CO₂ liquid tank to the valve 3 by way of a pressure line 2. A measurement device 4 is situated ahead of the valve 3, to monitor the liquid CO₂ level. The valve 3 is directly connected with the cleaning head 5. The cleaning head 5 is held in the housing by means of the nut 6. The cleaning pipe 8 is positioned by means of the union nut 9. For cleaning, the tandem burner 21 is moved from the working position into the starting position 22, and oriented in such a manner that the center line 23 of the tandem burner 21 lines up with that of the cleaning pipe 8. From this position, the tandem burner 21 is pivoted by an angle 24, so that the contact pipe 25 lies on the center line 14, together with the cleaning pipe 8. After orientation, the pivoted tandem burner 21 moves out of the starting position 22 into the first cleaning position 26. If the measurement device 4 confirms, by means of the signal 15, that CO₂ liquid is present, the robot gives the signal 16 for opening the valve 3. The liquid CO₂ flows through the nozzle openings 17 into the cleaning pipe 8 and relaxes, with simultaneous slight condensation, to form CO₂ snow that is blown onto the exit opening of the gas nozzle 27 by means of the pressure in the bottle 1. The required pressure equalization is achieved by means of the equalization bores 20. Once part of the exit opening of the gas nozzle 27 has been cleaned, the tandem burner 22 moves from the first cleaning position 26 into the second cleaning position 28. In this connection, the contact pipe 25 moves into and the gas nozzle 27 moves over the cleaning pipe 8. Once the position 28 has been reached, the valve 3 is opened by means of the signal 16 and CO₂ snow is again blown into the cleaning pipe 8. Because of the contact pipe 25 being moved into the cleaning pipe 8, the CO₂ snow is necessarily guided past the contact pipe 25 and the inside surface of the gas nozzle 27. After successful cleaning, the tandem burner 21 moves back into the starting position 22. The tandem burner 21 is pivoted, in this position, by the angle 24, into the starting position, and further, by the same angle 24, towards the other side, in such a manner that the contact pipe 29 is on the same center line 14 with the cleaning pipe 8. Cleaning takes place in the same manner as in the case of the contact pipe 25. After the second contact pipe has also been cleaned, the tandem burner moves back into the starting position 22, pivots back into the starting position by the angle 24, and from there into the working position.

### EXAMPLE 3

The cleaning pipe with inside bores 30 is set onto the cleaning head in Example 1 and positioned in place by means of the enlarged union nut 34. As a function of the cleaning program, the welding burner 10 moves either into the first position 18 for cleaning the gas exit opening of the gas nozzle 13, whereby the liquid CO₂ is blown onto the gas exit opening directly ahead of the gas nozzle 13, out of the inside bores 31 of the cleaning pipe with inside bores 30, forming CO₂ snow, or immediately into the second cleaning position 19, where the compulsory guidance of the CO₂ snow, which is influenced by the heat capacity that is dependent on the material and thickness of the wall of the cleaning pipe with inside bore 30, cleans the contact pipe 12 and the inside wall of the gas nozzle 13 at the same time. To avoid build-up of pressure and in order to transport the welding spatters that are loosened by means of the thermotension, several ventilation bores 32 are made in the cleaning pipe with inside bores 30. To remove the loosened spatters along the gas nozzle from the cleaning pipe with inside bores 30, air exit openings 33 are provided in the enlarged union nut 34.

### EXAMPLE 4

The stepped cleaning pipe 35 is set onto the cleaning head 5 in Example 1 and fixed in its position by means of the adapted union nut 36. As a function of the cleaning program, the welding burner 10 moves either into the position 18 for cleaning the gas exit opening of the gas nozzle 13, or over the contact pipe 12 with the stepped region 37. The welding burner 10 is moved so far over the contact pipe 12 until the nozzle crown is situated in the position 19 and the nozzle crown 39 is situated in the position 18. The nozzle crowns 38 and 39 become active by means of activation of various valves. Cleaning takes place by means of alternately or simultaneously turning on the valves. The stress-relief bore 40 prevents build-up of pressure, and the air bores 41 eliminate the residues from the stepped cleaning pipe 35.

### REFERENCE SYMBOLS

1 CO₂ liquid tank
2 pressure line
3 valve
4 measurement device
5 cleaning head
6 nut
7 housing
8 cleaning pipe
9 union nut
10 welding burner
11 starting position
12 contact pipe
13 gas nozzle
14 center line
15 signal (CO₂ liquid)
16 signal (valve)
17 nozzle openings
18 first cleaning position (single-wire burner)
19 second cleaning position (single-wire burner)
20 equalization bore
21 tandem burner
22 starting position
23 center line
24 angle
25 contact pipe I
26 first cleaning position (tandem burner)
27 gas nozzle
28 second cleaning position (tandem burner)
29 contact pipe II
30 cleaning pipe with interior bores
31 interior bore
32 ventilation bores
33 air exit openings
34 enlarged union nut
35 stepped cleaning pipe
36 adapted union nut
37 stepped region
38 nozzle crown
39 nozzle crown
40 stress-relief bore
41 air bore

1: Method for cleaning welding burners, using a cold blasting agent, wherein the liquid CO₂, which is under pressure in a tank (1), is uniformly blown into an interchangeable cleaning sleeve (8) that is adapted to the burner, at the bottom of the cleaning sleeve (8), using one or more jet nozzles (17), and that CO₂ snow is formed by the simultaneous relaxation, which snow condenses because of the small inside diameter of the cleaning sleeve (8) and the CO₂ that continues to flow in, and is partly converted to the gaseous state due to the heat capacity of the cleaning sleeve (8), and, at the same time, is guided onto a certain region of the burner (10) to be cleaned, compulsorily guided by means of the pressure of the liquid CO₂ and the gas phase of the CO₂, which is increasing in volume, whereby the burner (10) supports this compulsory guidance by means of moving to several cleaning positions (18, 19), and the loosened contaminants are removed from the burner region by means of the flows that occur, caused by the compulsory guidance and supported by the equalization bores (20).

2: Method according to claim 1, wherein blowing in of the liquid CO₂ into the cleaning pipe (8) takes place in interval-like manner.

3: Method according to claim 1, wherein the sum of the exit surface of the jet nozzles (17), in order to obtain an effective condensation, must stand in a certain ratio to the inside surface of the cleaning pipe (8).

4: Device for implementing the method for cleaning welding burners, using a cold blasting agent, preferably CO₂ snow, wherein a cleaning pipe (8) that is adapted to the burner (10, 21) in terms of length, diameter, and shape, which pipe possesses one or more jet nozzles (17) for blowing in liquid CO₂ at its bottom, whereby the sum of the cross-sections of the jet nozzles (17) is adapted to the cleaning pipe (8) in terms of shape and size, in a certain ratio, after orientation is situated on the same center line (14) with the contact pipes (12, 25, 29) in a position for accommodation of the burner (10, 21), whereby the contact pipe (12, 25, 29) moves into and the gas nozzle (13, 27) moves over the cleaning pipe (8), by means of displacement of the burner (10, 21).

5: Device according to claim 4, wherein the welding burner (10, 21) is fixed in place and that movement to the cleaning positions (18, 19, 26, 28) and passage over the cleaning pipe (8) by the welding burner (10, 21) is implemented by means of the device, which is mounted on an axially displaceable sled.

6: Device for implementing the method for cleaning welding burners, using a cold blasting agent, preferably CO₂ snow, wherein a cleaning pipe with inside bores (30) that is adapted to the burner (10, 21) in terms of length, diameter, and shape can be positioned relative to the welding burner (10, 21) in such a manner that the liquid CO₂ that flows out of the crown of the inside bores (31) under pressure, forming CO₂ snow, is directly guided onto the face surface of the gas nozzle (13, 27) and subsequently the contact pipe(s) (12, 25, 29) move so far into the cleaning pipe with inside bores (30) that the welding burner (10) is cleaned from the inside, by means of renewed short-term inflow of liquid CO₂, with the simultaneous formation of CO₂ snow, whereby the CO₂ snow simultaneously cleans the contact pipe (12, 25, 29) and the inside surface of the gas nozzle (13, 27), whereby the ventilation bores (32) prevent build-up of pressure, and allow outflow of the CO₂ snow/gas mixture with the loosened contaminants.

7: Device for implementing the method for cleaning welding burners, using a cold blasting agent, preferably CO₂ snow, wherein a stepped cleaning pipe (35) that is adapted to the burner (10, 21) in terms of length, diameter, and shape can be positioned relative to the welding burner (10), either in the first station, in such a manner that the liquid CO₂ that flows out of the nozzle crown (38) under pressure, forming CO₂ snow, directly impacts the exit opening of the gas nozzle (13, 27), or that the stepped cleaning pipe (35), which corresponds to the difference between the positions (18, 19) with its stepped region (37), moves over the contact pipe(s) (12, 25, 29) in such a manner that the nozzle crown (38) stands in the position (19) and the nozzle crown (39) stands in the position (18), and the corresponding regions of the burner (10, 21) can be cleaned simultaneously or at intervals, whereby the air exit openings (33) prevent build-up of pressure, and the air bores (41) allow cleaning of the stepped cleaning sleeve (35).
